(19) United States
(12) Patent Application Publication
(10) Pub. No.: US 2019/0096153 A1
(43) Pub. Date: Mar. 28, 2019

(54) SMART DIGITAL DOOR LOCK AND METHOD FOR CONTROLLING THE SAME

(71) Applicant: WOOSUNG HIGH-TECH CO.,LTD., Gumi-si (KR)

(72) Inventors: Hyunchul CHO, Daegu (KR); Jintae Park, Pohang-si (KR)

(73) Assignee: WOOSUNG HIGH-TECH CO.,LTD., Gumi-si (KR)

(21) Appl. No.: 16/104,703

(22) Filed: Aug. 17, 2018

(30) Foreign Application Priority Data
Sep. 26, 2017 (KR) 10-2017-0124488

(51) Int. Cl. G07C 9/00

(52) U.S. Cl. CPC G07C 9/00896

(57) ABSTRACT

A smart digital door lock configured to selectively lock a door according to the present invention includes an object detecting sensor configured to detect a front object, a camera module configured to capture a front image in a case in which it is determined that an arbitrary object approaches within a preset range as a result of detecting performed by the object detecting sensor, and a communication module configured to transmit image data captured by the camera module to a main server.

### CROSS-REFERENCE TO RELATED APPLICATION

This application claims priority of Korean Patent Application No. 2017-0124488, filed on Sep. 26, 2017, the disclosure of which is incorporated herein by reference in its entirety.

### FIELD OF THE INVENTION

The present invention relates to a smart digital door lock and a method for controlling the same, and more particularly, to a smart digital door lock, in which convenience and security are improved as compared to a conventional smart digital door lock, and a method for controlling the same.

### BACKGROUND OF THE INVENTION

Recently, since various types of crimes and threats of terrorism have rapidly increased, there is a growing interest in real-time monitoring systems to prevent crimes and threats of terrorism from happening, and thus related markets are growing rapidly.

In addition, digital door locks, which are located at boundary portions between spaces such as a house and an office in which safety is secured and outdoor areas, play an important role in security and safety and are widely used as security units.

However, until now, the digital door locks have been disadvantageous in that the digital door locks have been vulnerable in terms of security and safety due to their bias in convenience as reported several times through media and the like.

Although products in which smart digital door locks operate in conjunction with an access point (AP) of a Home Internet of things (IoT) and which inform of and record a door open alarm and details of the door open alarm in real time to take an action to respond to an unexpected situation have been accordingly released as of recent (for example, Korean Patent Application No. 20-2008-0004147), a fragmented situation, such as door opening, is insufficient to specifically determine a situation occurring in front of a door.

### SUMMARY OF THE INVENTION

The present invention is directed to providing a smart digital door lock, in which security and convenience are maximized as compared to a conventional smart digital door lock, and a method for controlling the same.

Objectives of the present invention are not limited to the objectives described above, and the other objectives which are not described above will be clearly understood by those skilled in the art from the following specification.

According to an aspect of the present invention, there is provided a smart digital door lock configured to selectively lock a door and including an object detecting sensor configured to detect a front object, a camera module configured to capture a front image in a case in which it is determined that an arbitrary object approaches within a preset range as a result of detecting performed by the object detecting sensor, and a communication module configured to transmit image data captured by the camera module to a main server.

The smart digital door lock may further include an illuminance sensor configured to detect front illuminance, and a light-emitting module configured to emit light forward in a case in which it is determined that an illuminance value is less than a reference value as a result of detecting performed by the illuminance sensor.

The smart digital door lock may further include a telephone module provided to make a call to an approaching object.

Meanwhile, according to another aspect of the present invention, there is provided a method for controlling the smart digital door lock, wherein the method includes an (a) operation in which the object detecting sensor detects whether a front object is present, a (b) operation in which the camera module captures a front image in a case in which it is determined that an arbitrary object has approached within a preset range as a result of the detecting performed by the object detecting sensor, a (c) operation in which it is determined whether the front object is an approaching object through the image data captured by the camera module, a (d-1) operation in which a mode is changed to a non-active mode in a case in which the front object is not an approaching object as a result of the determination of whether the front object is the approaching object, and a (d-2) operation in which the communication module transmits the image data to the main server in a case in which it is determined that the front object is the approaching object as the result of the determination of whether the front object is the approaching object.

The smart digital door lock may further include an illuminance sensor configured to detect front illuminance and a light-emitting module configured to emit light forward, and an (ex-1) operation in which the illuminance sensor determines front illuminance, and an (ex-2) operation in which the light-emitting module emits light forward in a case in which it is determined that an illuminance value is less than a reference value as a result of the illuminance determination performed by the illuminance sensor may be further included between the (a) operation and the (b) operation

The (c) operation may determine that, when a prestored reference image is compared to the image data captured by the camera module, it is determined that the front object is not the approaching object in a case in which a pixel change does not occur, or the front object is the approaching object in a case in which a pixel change occurs.

The method may further include an (e) operation in which the main server transmits an alarm, which informs of presence of data to be received by a user terminal, to the user terminal after the (d-2) operation.

The method may further include an (f) operation in which the user terminal accesses the main server and downloads the image data after the (e) operation.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a view illustrating a smart digital door lock according to one embodiment of the present invention;

FIG. 2 is a view illustrating operation of the method for controlling the smart digital door lock according to one embodiment of the present invention;

FIG. 3 is a view illustrating a communication process of the smart digital door lock according to one embodiment of the present invention; and

FIGS. 4 to 12 are views illustrating example screens of a software which is installed in a user terminal and operates in conjunction with the smart digital door lock according to one embodiment of the present invention.

FIG. 13 shows how an automatic call is made as the software automatically makes a call to the police or fire department by using a communication function of the user terminal.

FIG. 14 illustrates a screen wherein various alarms are set.

### DETAILED DESCRIPTION OF THE INVENTION

The exemplary embodiments for specifically realizing the objectives of the present invention will be described with reference to the accompanying drawings. While describing the embodiment, the same components are rendered the same names and numerals, and additional descriptions thereof will be omitted.

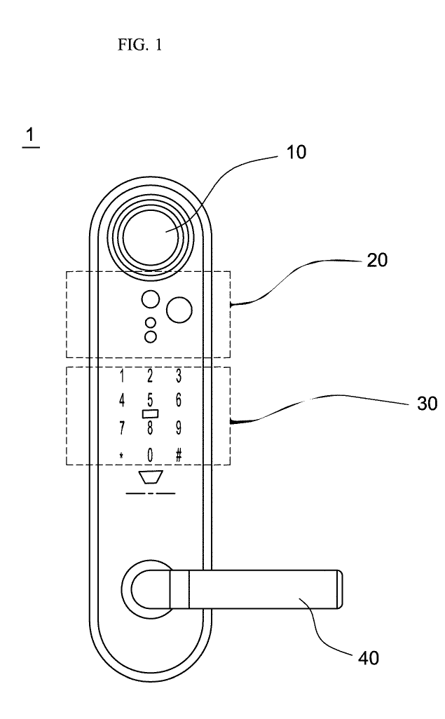

FIG. 1 is a view illustrating a smart digital door lock 1 according to one embodiment of the present invention.

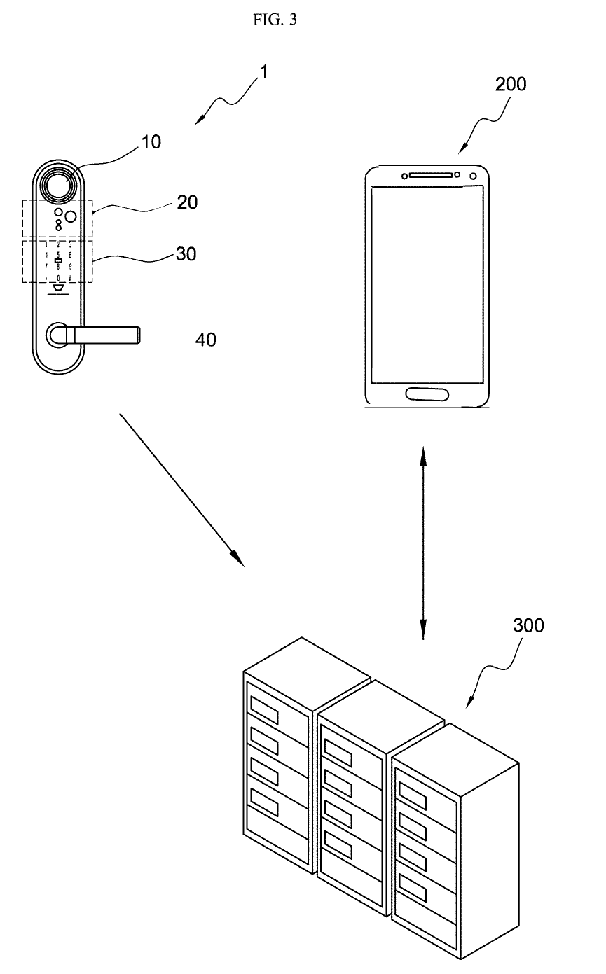

As illustrated in FIG. 1, the smart digital door lock 1 according to one embodiment of the present invention may include a functional portion 20 having an object detecting sensor configured to detect a front object, a camera module 10 configured to capture a front image in a case in which it is determined that an arbitrary object has approached within a set range as a result of the detecting performed by the object detecting sensor, a communication module (not shown) configured to transmit image data captured by the camera module 10 to a main server 300 (see FIG. 3), a button portion 30 for lock release and the like, and a handle 40.

Here, one of various sensors such as a passive infrared (PIR) sensor may be used as the object detecting sensor.

In addition, the functional portion 20 may further include a telephone module which includes a speaker, a microphone, and the like and which is provided for making a call to an approaching person, an illuminance sensor configured to detect front illuminance, a light-emitting module configured to emit light forward in a case in which it is determined that an illuminance value is less than a reference value as a result of the illuminance detecting performed by the illuminance sensor, and the like.

In addition, the smart digital door lock 1 according to one embodiment of the present invention may further include a processor (not shown) for processing various operations, a fire detecting sensor, a battery management module configured to determine remaining battery, and the like, and since structures of the processor and the fire detecting sensor are clear to those in the art, detailed descriptions thereof will be omitted.

Hereinafter, the method for controlling the smart digital door lock according to one embodiment of the present invention will be described.

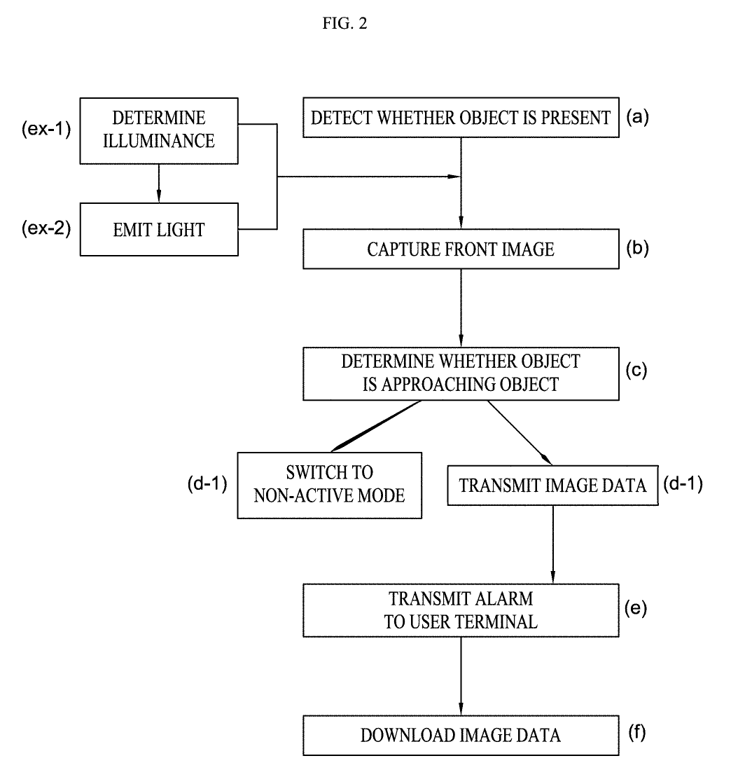

FIG. 2 is a view illustrating operation of the method for controlling the smart digital door lock according to one embodiment of the present invention.

As illustrated in FIG. 2, the method for controlling the smart digital door lock according to one embodiment of the present invention includes: an (a) operation in which the object detecting sensor detects whether an object is present in front of the smart digital door lock, a (b) operation in which, in a case in which it is determined that an arbitrary object has approached within a set range as the result of the detecting performed by the object detecting sensor, the camera module 10 captures an image in front of the of the smart digital door lock, a (c) operation in which whether the front object is an approaching object is determined through image data captured by the camera module 10, a (d-1) operation in which, in a case in which it is determined that the front object is not the approaching object as a result of the determination of whether the front object is the approaching object, a mode is switched to a non-active mode, and a (d-2) operation in which, in a case in which it is determined that the front object is the approaching object as the result of the determination of whether the front object is the approaching object, the image data is transmitted to the main server through the communication module.

In addition, between the (a) operation and the (b) operation, the method may further include an (ex-1) operation in which the illuminance sensor determines front illuminance, and an (ex-2) operation in which, in a case in which it is determined that the illuminance value is less than a reference value as a result of the illuminance determination performed by the illuminance sensor, light is emitted forward by the light-emitting module.

In addition, after the (d-2) operation, the method may further include an (e) operation in which the main server 300 (see FIG. 3) transmits an alarm, which informs of presence of data which has to be received by a user terminal 200 (see FIG. 3), to the user terminal 200, and an (f) operation in which the user terminal 200 (see FIG. 3) accesses the main server 300 (see FIG. 3) and downloads the image data.

Hereinafter the operations will be described in more detail.

The (a) operation starts by switching all components, which are in non-active states for effective power management, to active states in a case in which motion of an arbitrary object approaching the door, in which the smart digital door lock 1 according to the present invention is installed, is detected,

In addition, in a case in which it is determined that the arbitrary object has approached within a set range because of the detecting performed by the object detecting sensor in the (a) operation, the camera module 10 captures an image in front of the smart digital door lock 1 in the (b) operation.

Here, prior to capturing the image, when the illuminance sensor determines front illuminance in the (ex-1) operation and in a case in which it is determined that an illuminance value is less than a reference value as the result of the illuminance determination performed by the illuminance sensor, the light-emitting module may emit light forward in the (ex-2) operation so that an ample amount of light is secured when the image is captured in the (b) operation.

Then, in the (c) operation, it may be determined whether the front object is an approaching object through the image captured by the camera module 10.

In the case of the present invention, an algorithm is used in the (c) operation, wherein the algorithm compares a reference image stored in advance with the image data captured by the camera module 10, and determines that the front object is not the approaching object in a case in which pixels of the image data are not changed from those of the reference image, or determines that the front object is the approaching object in a case in which a pixel change occurs.

However, the present operation is not limited to the above-described present embodiment. For example, various methods such as a method, in which the object detecting sensor determines whether the front object stays for a time more than a predetermined time, and in a case in which the front object stays for the time more than the predetermined time, the object detecting sensor determines that the front object is the approaching object, may be used in the present operation.

In a case in which it is determined that the front object is not the approaching object as the result of the determination of whether the front object is the approaching object in the (c) operation, the (d-1) operation in which all the components are switched to a non-active mode is performed, and in a case in which it is determined that the front object is the approaching object as the result of the determination of whether the front object is the approaching object, the (d-2) operation in which the image data captured in the (b) operation is transmitted the main server 300 (see FIG. 3) through the communication module is performed.

In the (d-2) operation, the image data may be transmitted through communication performed through a local area network (LAN) or a wireless communication of wireless fidelity (Wi-Fi) or the like, and a process for which lens distortion of the image data is compensated may be further performed prior to the transmission. In addition, in a case in which the smart digital door lock 1 further includes a memory, the image data may be stored in the memory.

Then, the image data transmitted to the main server 300 (see FIG. 3) may be stored in a database of the main server 300 (see FIG. 3), and the main server 300 (see FIG. 3) may transmit an alarm, which informs of presence of data to be received by the user terminal 200 (see FIG. 3), to the user terminal 200 (see FIG. 3) in the (e) operation.

Accordingly, a user identifies the corresponding alarm through a push message on the user terminal 200 (see FIG. 3), and subsequently, the user accesses the main server 300 (see FIG. 3) through the user terminal 200 (see FIG. 3) and downloads the image data in the (f) operation.

In the present embodiment, although the transmission process of the image data has been described, a door detecting sensor configured to detect door opening is further included in the smart digital door lock 1, and in a case in which a door opens, door opening information and the like may be transmitted to the user terminal 200 (see FIG. 3) through a process the same as the above-described process.

Meanwhile, as described above, the smart digital door lock 1 may include a telephone module capable of making a call to the approaching object, and accordingly, the user may also make a video call to the approaching object through the user terminal 200 (see FIG. 3).

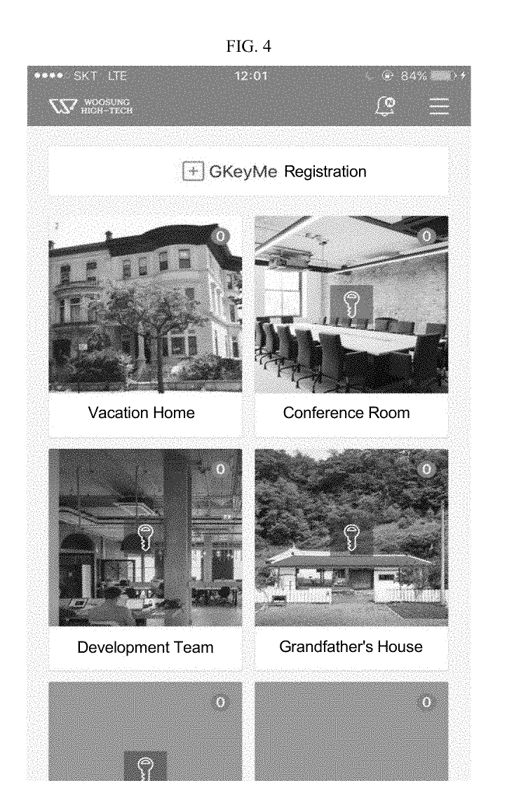

FIGS. 4 to 6 are views illustrating example screens of a software installed in the user terminal 200 (see FIG. 3) and configured to operate in conjunction with the smart digital door lock 1 according to one embodiment of the present invention.

As illustrated in FIG. 4, a main screen of the software installed in the user terminal 200 (see FIG. 3) may display N on an inform button when a new event occurs, and may include set buttons to which various profiles, alarms, a password lock, notices, and the like are set.

In addition, in the software, a product may be registered by selectively inputting a serial number thereof when installed, and accordingly authority may be assigned to the user. Here, master's authority which is a relatively high level of authority may also be assigned to an initial installer of the product.

In addition, a list of locations in which smart digital door locks 1 are installed may be displayed in the screen of the software, and the locations may be displayed as images to improve identification ability.

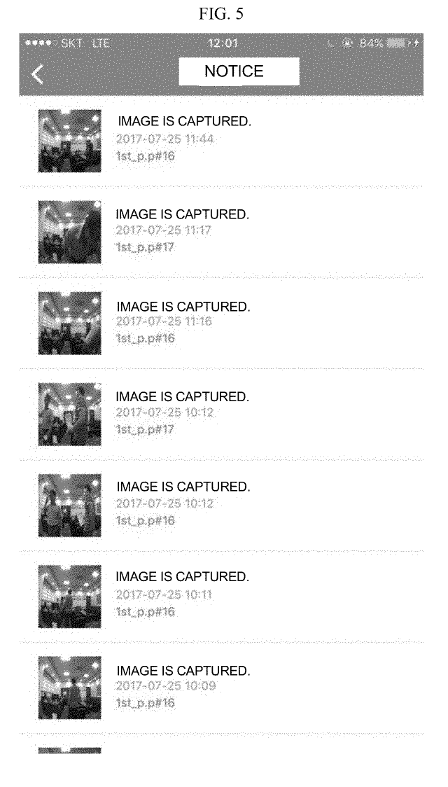

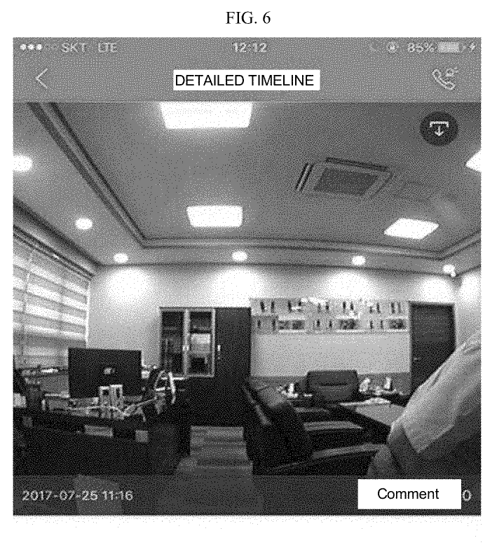

Meanwhile, in a case in which an alarm button is clicked, as illustrated in FIG. 5, a list of image data to be received may be displayed on the screen, and in a case in which any one piece of the image data is clicked, the piece of the image data may be displayed on the screen of the user as illustrated in FIG. 6 through a process in which the image data is downloaded.

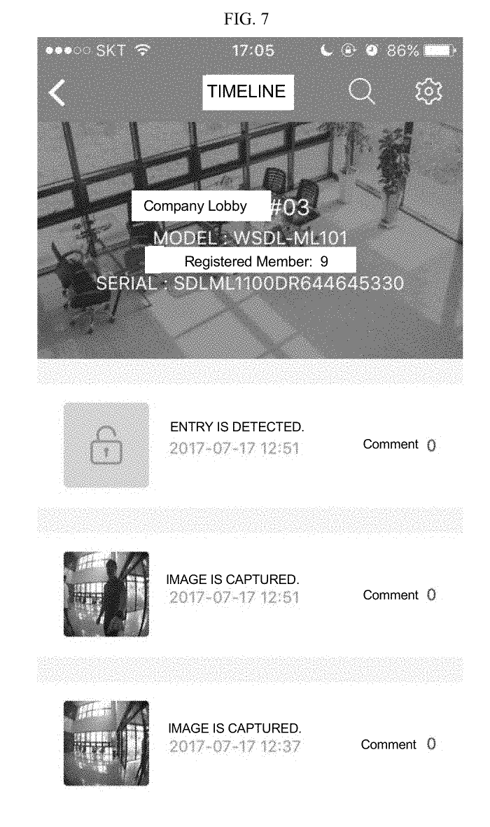

In addition, as illustrated in FIGS. 7 to 12, the software may further include a timeline function such that a plurality of registered members shares functions and interact with each other.

An event search button and a set button are displayed on the present screen, a specific desired event may be selected from various categories such as total events, an entrance event, a fire event, a battery event, a damage event, an imaging event, and the like and may be found by the event search button. In addition, the set button may provide a product installation place function, a background image change function, a member disconnection function, and the like.

In addition, the present screen may include a product information display screen which provides the product installation place function, the background image change function, and the member disconnection function, and an event output screen which outputs events which occur. Here, detailed information may be identified by clicking the events, and a comment function is provided in the screen so that members may write opinions of the members on the screen. In addition, lock/unlock of each event may be set according to setting.

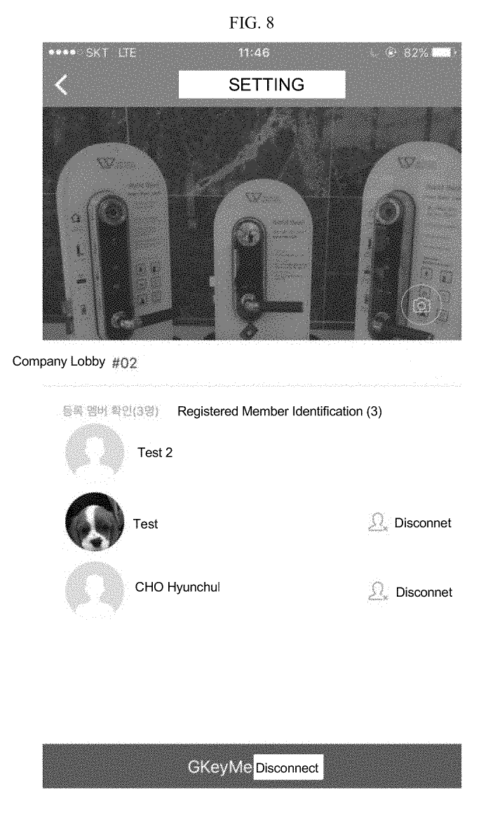

FIG. 8 is a view illustrating a setting screen of the user having master's authority, and the authority, in which a real time image and a member may be identified, and a state of connection thereof may be managed, may be assigned to the user.

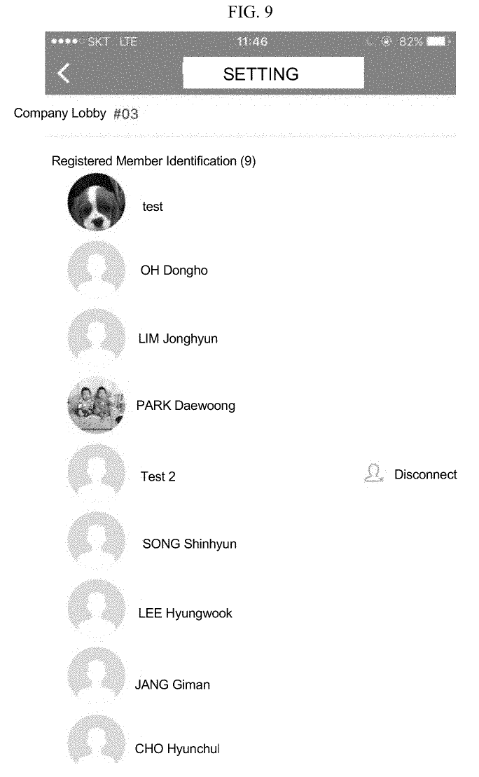

FIG. 9 is a view illustrating a setting screen of a general user, a corresponding member list may be provided in the setting screen and chatting, and the like may be activated between members and may be used between one member and one or a plurality of members.

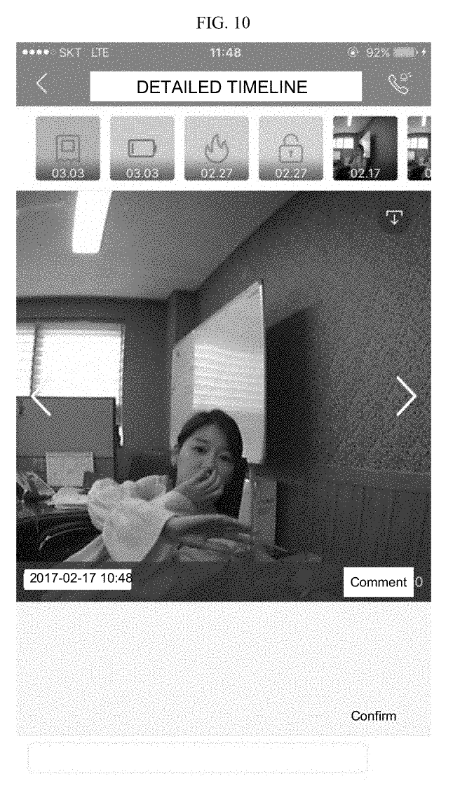

In addition, FIG. 10 is a view illustrating a detailed timeline screen.

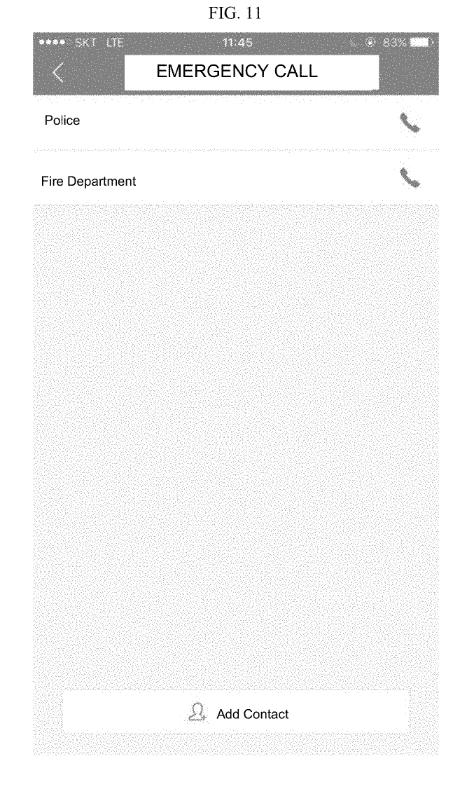

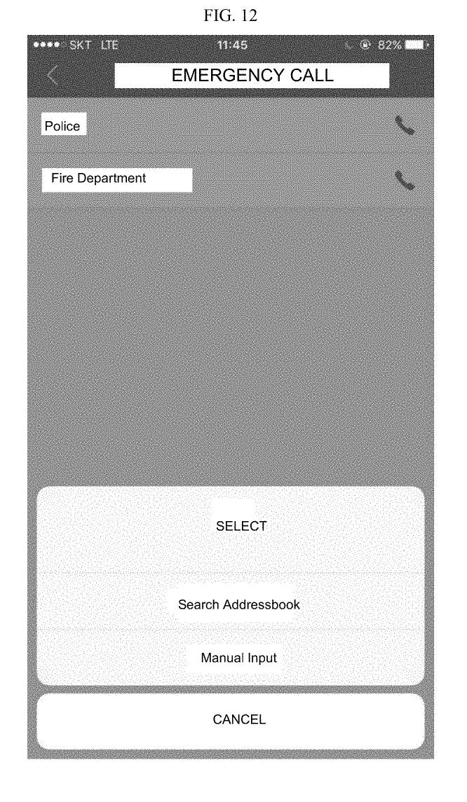

An emergency call button is provided at an uppermost end of the present screen, and a thumbnail screen in which icons are displayed according to events is provided below the emergency call button. See FIGS. 11 and 12.

A call may be made to a set emergency contact such as a police station/fire station (basic value), a family member/security company (user added value), and the like by clicking the emergency call button when an emergency situation occurs, and events which occur at various categories such as damage, a battery, fire, entrance, and the like may be identified through images or icons in the thumbnail screen.

In addition, in a case in which a corresponding icon is clicked, a detailed event output screen is provided at a lower portion of the screen, and a storage button for storing an output image in the user terminal, a moving button configured to move between events, and operation display lines, in which an imaging date/imaging time, the number of comments, and the like are output, are displayed in the present screen.

By clicking the emergency call button when an emergency occurs, a call may be made to the police station/fire station stored as the basic value as illustrated in FIG. 11, or a call may be made to the user added value such as the family member/security company registered through an additional registration process as illustrated in FIG. 12.

Although the present function may also be manually performed, a call may also be automatically made to the above-described emergency contacts in the software when a specific event occurs.

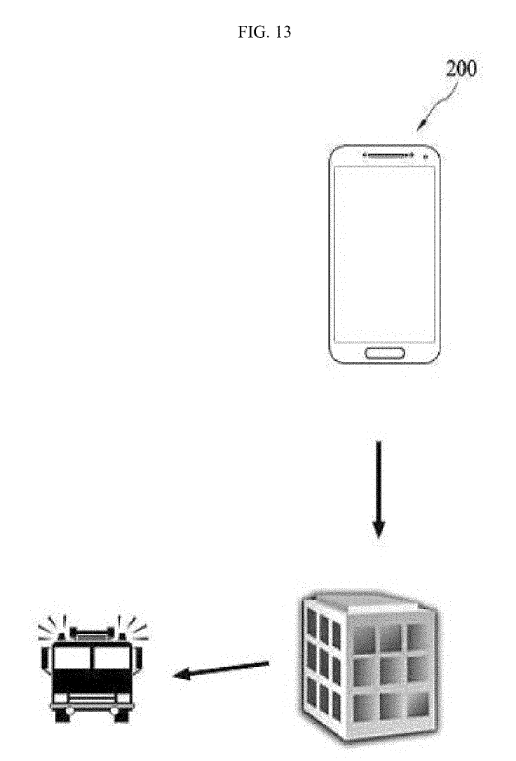

For example, when an event which satisfies an automatic call condition occurs, the software may automatically make a call to the police station/fire station by using a communication function of the user terminal as illustrated in FIG. 13 and may also transmit related information such as an image of the occurred event to a representative terminal/server and the like of a corresponding organization.

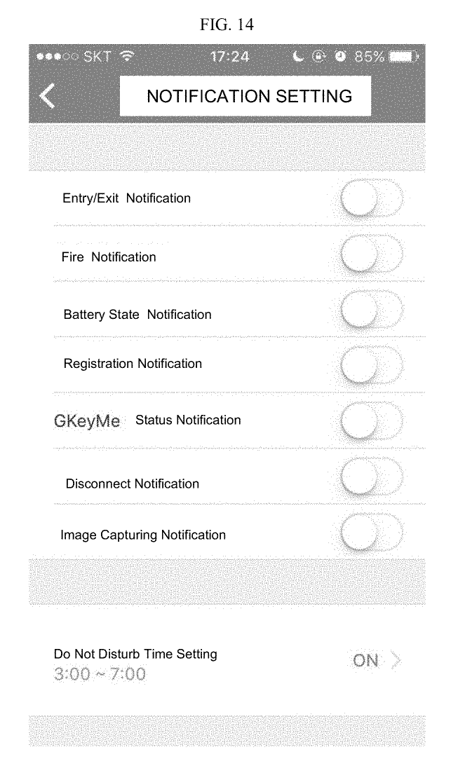

Meanwhile, as illustrated in FIG. 14, the present software may provide a screen in which various alarms are set. In the present screen, push messages related to various events may be set by turning on/off, and as an exception of the present setting, a ‘do not disturb time’ may be further set in the present screen.

As described above, a smart digital door lock and a method for controlling the same for solving the above-described objectives has the following effects.

First, since an approaching person is detected, and an image thereof is captured, and the image is transmitted in real time by an object detecting sensor, there is an advantage in that a user can easily determine whether the corresponding approaching person is a family member or acquaintance.

Second, in addition, in a case in which a door opens, since corresponding information is transmitted in real time, there is an advantage in that convenience and security can be maximized by estimating and determining a situation in front of the door through the door open information and transmitted image data of the approaching person.

Third, since the user can perform communication through additional components such as a microphone and a speaker, there is an advantage in that the user can directly communicate with an approaching person or visitor to take an action according to determination of the user as necessary.

Effects of the present invention are not limited to the above-described effects, and other effects which are not described above will be clearly understood by those skilled in the art through the appended claims.

The exemplary embodiments of the present invention have been described as described above, and it will be clear to those skilled in the art that the present invention will be realized into a different specific form without departing from the spirit or scope of the present invention other than the above-described embodiments. Accordingly, the above-described embodiments should be considered in a descriptive sense only and not for purposes of limitation, and the present invention is not limited to the above description and may also be changed within the scope of the appended claims and all equivalents falling within the scope.

1. A smart digital door lock configured to selectively lock a door, comprising:
an object detecting sensor configured to detect a front object;
a camera module configured to capture a front image in a case in which it is determined that an arbitrary object approaches within a preset range as a result of detecting performed by the object detecting sensor; and
a communication module configured to transmit image data captured by the camera module to a main server.

2. The smart digital door lock of claim 1, further comprising:
an illuminance sensor configured to detect front illuminance; and
a light-emitting module configured to emit light forward in a case in which it is determined that an illuminance value is less than a reference value as a result of detecting performed by the illuminance sensor.

3. The smart digital door lock of claim 1, further comprising a telephone module provided to make a call to an approaching object.

4. A method for controlling the smart digital door lock of claim 1 comprising:
(a) an object detecting sensor detecting if there is an object present in front of the sensor;
(b) a camera module capturing a front image if it is determined that an arbitrary object has approached within a preset range by step (a);
(c) determining whether the front object is an approaching object through the image data captured by the camera module;
(d-1) changing a mode to a non-active mode if it is determined that the front object is not an approaching object by step (c); and
(d-2) a communication module transmitting the image data to the main server if it is determined that the front object is an approaching object by step (c).

5. The method of claim 4, further comprising:
the smart digital door lock further comprising an illuminance sensor configured to detect front illuminance and a light-emitting module configured to emit light forward; and
the illuminance sensor determines front illuminance (ex-1), and the light-emitting module emits light (ex-2) forward if it is determined that an illuminance value is less than a reference value as a result of the illuminance determination performed by the illuminance sensor between (a) and (b) steps.

6. The method of claim 4, wherein step (c) determines that, when a prestored reference image is compared to the image data captured by the camera module, the front object is not the approaching object in a case in which a pixel change does not occur, or the front object is the approaching object in a case in which a pixel change occurs.

7. The method of claim 4, further comprising:
(e) operation in which the main server transmits an alarm, to inform a presence of data, to a user terminal.

8. The method of claim 7, further comprising
(f) the user terminal accessing the main server and downloads the image data.
p [symbol]
